(19) United States
(12) Patent Application Publication
(10) Pub. No.: US 2008/0014414 A1
(43) Pub. Date: Jan. 17, 2008

(54) Windshield Interlayer Having a Gradient Region Having a White Coloration

(76) Inventor: Vincent James Yacovone, Springfield, MA (US)

Correspondence Address: BRENC LAW;ANDREW BRENC, P.O. BOX 155, ALBION, PA, 16401-0155, US

(21) Appl. No.: 11/457,195

(22) Filed: Jul. 13, 2006

(51) Int. Cl. B41M 5/00

(52) U.S. Cl. 428/195.1

(57) ABSTRACT

The present invention includes windshields and windshield interlayers comprising a gradient region having a white coloration adjacent to which an image has been printed. The incorporation of a gradient region having a white coloration into a windshield provides a background that improves the color perception and quality of the printed image.

### FIELD OF THE INVENTION

The present invention is in the field of polymer sheets and multiple layer glass panels that are used in windshield applications, and, more specifically, the present invention is in the field of polymer sheets and multiple layer glass panels for use in windshield applications having a gradient region.

### BACKGROUND

Poly(vinyl butyral) (PVB) is commonly used in the manufacture of polymer sheets that can be used as interlayers in light-transmitting laminates such as windshields. The main function of an interlayer is to absorb energy, such as that caused by a blow from an object, without allowing penetration through the opening or the dispersion of shards of glass, thus minimizing damage or injury to the objects or persons within an enclosed area.

For windshield applications of polymeric interlayers, it is often desirable to apply a printed image to the finished windshield in a gradient region. Typically, gradient regions are formed at the top of a windshield, where they can function to, among other things, for example, filter light entering a vehicle.

In addition to filtration of light, gradient regions have also been used as an area on which images can be formed for aesthetic purposes. These images can be, for example, printed on the exterior surface of a laminated, multiple layer windshield. These images, unfortunately, often have less than desirable visual quality because of the substrate onto which they are formed.

Further improved windshields are therefore needed that allow for the use of gradient images having a very high visual quality.

### SUMMARY OF THE INVENTION

The present invention includes windshields and windshield interlayers comprising a gradient region having a white coloration on or adjacent to which an image has been printed. The incorporation of a gradient region having a white coloration into a windshield provides a background that improves the color perception and quality of the printed image.

### DETAILED DESCRIPTION

The present invention includes interlayers having a gradient region having a white coloration and a printed image, and windshields comprising those interlayers. The gradient region having a white coloration can be formed through various techniques in or on one or more layers of an interlayer. Printed images are formed over the gradient region having a white coloration, and, when viewed with the gradient region having a white coloration as a background, appear very clear and of very high quality.

Interlayers of the present invention can consist of a single polymer layer, for example a polymer sheet comprising poly(vinyl butyral), or interlayers can comprise multiple polymer layers disposed in contact with one another. In simplest form, an interlayer is a single polymer sheet having the appropriate physical characteristics. In other constructs, multiple polymer sheets can be combined to form a multiple layer interlayer. In further embodiments, polymer films can be included with polymer sheets to form multiple layer interlayers. Polymer sheets and polymer films can comprise any suitable material, as described in detail below.

Polymer sheets and polymer films can be combined in many ways to form interlayers of the present invention. For example, and without limitation, where n represents 1 to 10 iterations, and preferably 1, 2, or 3 iterations:
(polymer sheet)ₙ
(polymer sheet//polymer film)ₙ
(polymer sheet//polymer film//polymer sheet)ₙ
(polymer film//polymer sheet//polymer film)ₙ

Interlayers of the present invention comprise a gradient region having a white coloration. As used herein, a “gradient region” is the portion of a polymer sheet or polymer film that corresponds with the top portion of a windshield in a finished product in which gradients are conventionally formed. Gradient regions of the present invention can have any suitable height that does not obscure a driver's view. A gradient region can extend to the very top edge of an interlayer or it can be a stripe that is located at the top of the interlayer that leaves a small region above the gradient region that is not part of the gradient region.

As used herein, “having a white coloration” means having average CIELAB values as follows (in clear glass): “L” value from 40 to 100, an “a” of −15 to 15, and “b” of −5 to 20 over at least 80% of its area (linear width and length). Lab values are determined with a Byk-Gardner TCS Plus spectrophotometer Model 8870 in reflectance mode with spectral excluded. Data reported in CIELAB color space, D65 illuminant and 10 degree observer.

In various preferred embodiments, the L value of the white coloration is greater than 70.

As used herein, “substantially opaque” means allowing the transmission of less than 20% of visible light. In various embodiments of the present invention, a gradient region having a white coloration is substantially opaque. In various embodiments of the present invention, a gradient region having a white coloration is 100% opaque.

A gradient, by definition, is formed in or on a gradient region. As used herein, a “region of a layer corresponding to a gradient region” means the region of a layer that does not have a gradient formed thereon or therein that will be adjacent to, and thus correspond to, the gradient region in the finished product. For example, an image printed in this region of a first polymer sheet, which lacks a gradient region having a white coloration, will be positioned adjacent a gradient region having a white coloration of a second polymer sheet in the final windshield product. The net effect will be the formation of a windshield that, when viewed from the exterior, will have an image in front of a white background (the gradient region having a white coloration) even though the gradient region having a white coloration and the image are not formed on the same polymer sheet.

In various embodiments, white coloration can be formed in a gradient region so that the white color has consistent composition and optical character throughout the gradient region. In other embodiments, white coloration will change in a uniform or non-uniform manner to produce a gradient with the desired visual effect. For example, a gradient could range from clear to opaque in a linear, exponential, or discrete step change function, with, for example, optical density values ranging from zero to four within the gradient region. In further embodiments, white coloration can be formed in a defined subregion of the gradient region. For example, white coloration can be formed in a centered subregion of the gradient region that has the same height as the gradient region but only half the width, which results in a rectangular subregion of the gradient region having a white coloration. Many other shapes and distributions of white coloration within a subregion are possible and within the scope of the present invention.

For embodiments in which the gradient region having a white coloration is formed within a polymer layer, coextrusion or extrusion coating techniques can be used, for example. In coextruded embodiments, for example, a polymer melt comprising the polymer resin, plasticizer, added agents, and the white coloring agent are mixed and coextruded with a conventional polymer melt, resulting in a single polymer sheet having a gradient region formed therein in which white coloring agents are dispersed through the gradient region.

The choice among the various types of gradient regions will be made, of course, based upon the desired characteristics of the finished product. For example, the gradient region having a white colorations of the present invention allow for images to be formed in a finished windshield on both the inside and the outside of the finished product. For these types of embodiments, for example, a coextruded gradient region having a white coloration would allow for printing images on both sides of a single polymer sheet without the need for a printed gradient, which would simplify the final construct while allowing for high quality images on both viewing surfaces.

In various embodiments of the present invention in which a multiple layer interlayer is used, a polymer sheet with a printed or coextruded gradient region having a white coloration can be encapsulated in one or two skin layers. Skin layers can be, for example, from 0.05 millimeters to 0.10 millimeters. One example of this embodiment is a three polymer sheet layer embodiment having the following thicknesses: 0.5 millimeters//0.25 millimeters//0.05 millimeters. In this example, the gradient region having a white coloration and image are formed on the surface of the 0.25 millimeter layer that is disposed in contact with the 0.05 millimeter layer. By including a skin layer in this example, the image and gradient region having a white coloration are brought closer to the outside of the interlayer without putting the image in contact with the glass.

In various embodiments the printed image is printed directly on the gradient region having a white coloration. In embodiments in which the white coloration is itself formed on a polymer sheet or a polymer film, the printed image can be formed directly on the white colorant material. In embodiments in which the gradient region having a white coloration is formed within a polymer sheet or polymer film as a coextruded gradient, the printed image can be formed directly on the surface of the polymer sheet in the gradient region.

In other embodiments, the printed image can be printed on a surface other than on the gradient region having a white coloration. In these embodiments, the printed image can be printed on another layer within a multiple layer interlayer, or, for example on the side of a polymer sheet opposite a gradient formed on the opposite surface of that polymer sheet. In either case, the printed image is printed on a portion of a layer that corresponds to the gradient region in the finished product so that the combined effect is an image viewed against a white background. In various other embodiments, the printed image can be printed on one or more layers of glass within a finished windshield product.

In general, any combination of a gradient regions having a white coloration and printed images can be combined to result in a product that has viewable images in front of a gradient region having a white coloration on one or both sides of a finished windshield. Included among these variations, without limitation, are interlayers comprising a polymer sheet with both sides having a printed white coloration, interlayers comprising polymer films with both sides having a printed white coloration, interlayers comprising multiple layers wherein more than one layer has a printed white coloration, interlayers comprising multiple layers wherein more than one layer has a coextruded gradient region having a white coloration, and, generally, interlayers comprising one or more gradient regions having a white coloration, either printed or coextruded, and one or more printed images, either printed on the one or more gradient regions or printed on another layer in a region corresponding to the gradient region.

Gradient regions having a white colorations of the present invention can be formed either on or in a polymer sheet or on or in a polymer film. For embodiments in which white coloration is formed on a polymer sheet or a polymer film, any conventional method for applying the agent can be used. For example, coloration can be formed using digital, screen, rotary, laser, inkjet printing, gravure, spray coating, dipping, airbrush, and masking, among others. Conventional graphic art design computers can be used for design work.

For coloration formed within a polymer sheet via coextrusion, appropriate pigments and other agents can be added directly to a polymeric resin and plasticizer, where applicable, in a polymer melt.

Any suitable colorant can be used, and, in preferred embodiments, pigments are used as colorants. Particularly useful pigments include titanium dioxide and calcium carbonate, which can be incorporated into or onto polymer sheets or polymer films of the present invention in any suitable concentration. Other useful pigments include silica, zirconia, barium sulfate, calcium sulfate, glass, zinc oxide, and zinc sulfide.

Gradient regions can have any suitable height, as measured from the bottom of the gradient region to the top of the gradient region in a finished windshield in position in a vehicle, and can be less than 20 centimeters, less than 18 centimeters, or less than 15 centimeters in height. As described elsewhere, the gradient region can be formed at the very top of an interlayer, or it can be located somewhat below the very top of an interlayer. For larger interlayers, such as those used for trucks and buses, a gradient region can be larger than 20 centimeters, as required to provide a proportionally acceptable gradient—for example, 30% or less, 25% or less, or 20% or less of the windshield length, as measured from the top edge to the bottom edge.

As used herein, an “image” is any printed graphical representation, including, for example and without limitation, geometric patterns and shapes, alphanumeric characters, artistic images, and the like. Image printing is well known in the art, and conventional methods, such as gravure and inkjet printing, can be used to form an image gradient region having a white coloration of the present invention. Any suitable conventional inks can be used to form the image.

Polymer Film

As used herein, a “polymer film” means a relatively thin and rigid polymer layer that functions as a performance enhancing layer. Polymer films differ from polymer sheets, as used herein, in that polymer films do not themselves provide the necessary penetration resistance and glass retention properties to a multiple layer glazing structure, but rather provide performance improvements, such as infrared absorption character. Poly(ethylene terephthalate) is most commonly used as a polymer film.

In various embodiments, the polymer film layer has a thickness of 0.013 mm to 0.20 mm, preferably 0.025 mm to 0.1 mm, or 0.04 to 0.06 mm. The polymer film layer can optionally be surface treated or coated to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known, (see, for example, U.S. Pat. Nos. 4,017,661 and 4,786,783), the metal layer(s) may optionally be electrically resistance heated for defrosting or defogging of any associated glass layers.

An additional type of polymer film that can be used with the present invention, which is described in U.S. Pat. No. 6,797,396, comprises a multitude of nonmetallic layers that function to reflect infrared radiation without creating interference that can be caused by metallic layers.

The polymer film layer, in some embodiments, is optically transparent (i.e. objects adjacent one side of the layer can be comfortably seen by the eye of a particular observer looking through the layer from the other side), and usually has a greater, in some embodiments significantly greater, tensile modulus regardless of composition than that of any adjacent polymer sheet. In various embodiments, the polymer film layer comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film layer comprises materials such as re-stretched thermoplastic films having the noted properties, which include polyesters, for example poly(ethylene terephthalate) and poly(ethylene terephthalate) glycol (PETG). In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 minutes at 150° C.).

Various coating and surface treatment techniques for poly(ethylene terephthalate) film that can be used with the present invention are disclosed in published European Application No. 0157030. Polymer films of the present invention can also include a hardcoat and/or and antifog layer, as are known in the art.

Polymer Sheet

As used herein, a “polymer sheet” means any thermoplastic polymer composition formed by any suitable method into a thin layer that is suitable alone, or in stacks of more than one layer, for use as an interlayer that provides adequate penetration resistance and glass retention properties to laminated glazing panels. Plasticized poly(vinyl butyral) is most commonly used to form polymer sheets.

The polymer sheet can comprise any suitable polymer, and, in a preferred embodiment, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, polyvinyl chloride, poly(ethylene vinyl acetate), combinations thereof, and the like. In further embodiments the polymer sheet comprises poly(vinyl butyral) and one or more other polymers. Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known processes. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

In various embodiments, resin used to produce the polymer sheet comprising poly(vinyl butyral) comprises 10 to 35 weight percent (wt. %) hydroxyl groups calculated as poly(vinyl alcohol)(PVOH), 13 to 30 wt. % hydroxyl groups calculated as poly(vinyl alcohol), or 15 to 22 wt. % hydroxyl groups calculated as poly(vinyl alcohol). The resin can also comprise less than 15 wt. % residual ester groups, 13 wt. %, 11 wt. %, 9 wt. %, 7 wt. %, 5 wt. %, or less than 3 wt. % residual ester groups calculated as poly(vinyl acetate), with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight greater than 30,000, 40,000, 50,000, 55,000, 60,000, 65,000, 70,000, 120,000, 250,000, or 350,000 grams per mole (g/mole or Daltons). Small quantities of a dialdehyde or trialdehyde can also be added during the acetalization step to increase molecular weight to greater than 350,000 Daltons (see, for example, U.S. Pat. Nos. 4,874,814; 4,814,529; and 4,654,179). As used herein, the term “molecular weight” means the weight average molecular weight.

Polymer sheets can comprise 20 to 60, 25 to 60, 20 to 80, 10 to 70, or 5 to 100 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779, and C₆ to C₈ adipate esters, such as hexyl adipate. In preferred embodiments, the plasticizer is triethylene glycol di-(2-ethylhexanoate).

Adhesion control agents can also be include in the polymer sheets of the present invention to impart the desired adhesiveness. These agents can be incorporated into the outer sheets in a three polymer sheet embodiment, for example. Any of the ACAs disclosed in U.S. Pat. No. 5,728,472 can be used. Additionally, residual sodium acetate and/or potassium acetate can be adjusted by varying the amount of the associated hydroxide used in acid neutralization. In various embodiments, polymer sheets of the present invention comprise magnesium bis(2-ethyl butyrate)(chemical abstracts number 79992-76-0). The magnesium salt can be included in an amount effective to control adhesion of the polymer sheet to glass.

Additives may be incorporated into the polymer sheet to enhance its performance in a final product. Such additives include, but are not limited to, plasticizers, dyes, pigments, stabilizers (e.g., ultraviolet stabilizers), antioxidants, flame retardants, other IR absorbers, anti-block agents, combinations of the foregoing additives, and the like, as are known in the art.

Agents that selectively absorb light in the visible or near infrared spectrum can be added to any of the appropriate polymer sheets. Agents that can be used include dyes and pigments such as LaB₆, indium tin oxide, antimony tin oxide, or lanthanum hexaboride.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols. As used herein, “melt” refers to a mixture of resin with a plasticizer and, optionally, other additives.

One exemplary method of forming a poly(vinyl butyral) layer comprises extruding molten poly(vinyl butyral) comprising resin, plasticizer, and additives and then forcing the melt through a sheet die (for example, a die having an opening that is substantially greater in one dimension than in a perpendicular dimension). Another exemplary method of forming a poly(vinyl butyral) layer comprises casting a melt from a die onto a roller, solidifying the resin, and subsequently removing the solidified resin as a sheet. In either embodiment, the surface texture at either or both sides of the layer may be controlled by adjusting the surfaces of the die opening or by providing texture at the roller surface. Other techniques for controlling the layer texture include varying parameters of the materials (for example, the water content of the resin and/or the plasticizer, the melt temperature, molecular weight distribution of the poly(vinyl butyral), or combinations of the foregoing parameters). Furthermore, the layer can be configured to include spaced projections that define a temporary surface irregularity to facilitate the de-airing of the layer during lamination processes after which the elevated temperatures and pressures of the laminating process cause the projections to melt into the layer, thereby resulting in a smooth finish.

Fabrication of a multiple layer interlayer can be accomplished by using known techniques in the art, such as independently producing three layers of polymer sheet, and then laminating the three sheets together under appropriate conditions to yield a single, multiple layer interlayer.

In various embodiments a prelamination step can be added to any lamination process, wherein two or more polymer sheets and/or polymer films are tacked together with minimal heat and/or pressure to form a prelaminated interlayer or portion thereof. At a later stage in processing, the prelaminated is positioned in a laminate stack—for example between two glass panes—and then laminated.

In various embodiments, the interlayers of the present invention can have total thicknesses of 0.1 to 2.5 millimeters, 0.2 to 2.0 millimeters, 0.25 to 1.75 millimeters, and 0.3 to 1.5 millimeters (mm). The individual polymer sheets of a multiple layer interlayer can have, for example, approximately equal thicknesses that, when added together, result in the total thickness ranges given above. Of course, in other embodiments, the thicknesses of the layers can be different, and can still add to the total thicknesses given above.

The parameters for the polymer sheet described above apply as well to any layer in a multiple layer construct of the present invention that is a poly(vinyl butyral) type layer, where applicable.

The present invention includes windshields comprising an interlayer of present invention.

The present invention includes methods of making windshields, comprising laminating an interlayer of the present invention between two glass layers.

The following paragraphs describe various techniques that can be used to improve and/or measure the characteristics of the polymer sheet.

The visible transmittance can be quantified using a UV-V is-NIR spectrophotometer such as the Lambda 900 made by Perkin Elmer Corp. by methods described in international standard ISO 9050:1990. In various embodiments, the transmittance through a polymer sheet of the present invention is at least 60%, at least 70%, or at least 80%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) layer is then removed, and the amount of glass left adhered to the poly(vinyl butyral) layer is visually compared with a set of standards. The standards correspond to a scale in which varying degrees of glass remain adhered to the poly(vinyl butyral) layer. In particular, at a pummel standard of zero, no glass is left adhered to the poly(vinyl butyral) layer. At a pummel standard of 10, 100% of the glass remains adhered to the poly(vinyl butyral) layer. Poly(vinyl butyral) layers of the present invention can have, for example, a pummel value of between 3 and 10.

By virtue of the present invention, it is now possible to provide windshield interlayers for use in windshields having an image displayed in the gradient region, wherein those images have very high visual quality.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed having a gradient region in any of heights given in addition to any of the ranges given for thicknesses, where appropriate, to form many permutations that are within the scope of the present invention but that would be cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

I/We claim:

1. A windshield interlayer, comprising:
a polymer sheet;
wherein said interlayer comprises a gradient region having a white coloration, and wherein an image is printed on said gradient region or on a region of a layer within said interlayer corresponding to said gradient region.

2. The interlayer of claim 1, wherein said white coloration is formed on said polymer sheet.

3. The interlayer of claim 1, wherein said white coloration is formed within said polymer sheet.

4. The interlayer of claim 1, wherein said interlayer further comprises a second polymer sheet and wherein said white coloration is formed within said polymer sheet or said second polymer sheet.

5. The interlayer of claim 1, wherein said interlayer further comprises a polymer film and said white coloration is formed on said polymer film.

6. The interlayer of claim 1, wherein said white coloration is formed in a subregion of said gradient region.

7. The interlayer of claim 1, wherein said gradient region has a height of less than 18 centimeters.

8. The interlayer of claim 1, wherein said white coloration comprises titanium dioxide.

9. The interlayer of claim 1, wherein said image is printed directly on said gradient region.

10. The interlayer of claim 1, wherein said white coloration has a CIELAB color space L value of greater than 70.

11. A windshield, comprising:
an interlayer comprising a polymer sheet;
wherein said interlayer comprises a gradient region having a white coloration, and wherein an image is printed on said gradient region or on a region of a layer within said interlayer corresponding to said gradient region.

12. The windshield of claim 11, wherein said white coloration is formed on said polymer sheet.

13. The windshield of claim 11, wherein said white coloration is formed within said polymer sheet.

14. The windshield of claim 11, wherein said interlayer further comprises a second polymer sheet and wherein said white coloration is formed within said polymer sheet or said second polymer sheet.

15. The windshield of claim 11, wherein said interlayer further comprises a polymer film and said white coloration is formed on said polymer film.

16. The windshield of claim 11, wherein said white coloration is formed in a subregion of said gradient region.

17. The windshield of claim 11, wherein said gradient region has a height of less than 18 centimeters.

18. The windshield of claim 11, wherein said white coloration comprises titanium dioxide.

19. The interlayer of claim 11, wherein said image is printed directly on said gradient region.

20. The interlayer of claim 12, wherein said white coloration has a CIELAB color space L value of greater than 70.
